(19) United States
(12) Patent Application Publication
(10) Pub. No.: US 2026/0180083 A1
(43) Pub. Date: Jun. 25, 2026

(54) SECONDARY BATTERY POUCH FILM HAVING EXCELLENT WEIGHT REDUCTION AND STABILITY AND METHOD FOR DESIGNING SAME, AND SECONDARY BATTERY USING SAME AND METHOD FOR MANUFACTURING SAME

(71) Applicant: Youlchon Chemical Co., Ltd., Seoul (KR)

(72) Inventors: Nok Jung Song, Seoul (KR); Hee Sik Han, Gyeonggi-do (KR); Han Chul Park, Gyeonggi-do (KR); Jin Hee Yeon, Gyeonggi-do (KR)

(73) Assignee: Youlchon Chemical Co., Ltd., Seoul (KR)

(21) Appl. No.: 19/127,128

(22) PCT Filed: Nov. 3, 2023
(86) PCT No.: PCT/KR2023/017572

§ 371 Date: May 4, 2025

(30) Foreign Application Priority Data
Nov. 4, 2022 (KR) 10-2022-0145848
Nov. 2, 2023 (KR) 10-2023-0150351

(51) Int. Cl. H01M 50/131; H01M 50/105; H01M 50/126

(52) U.S. Cl. CPC H01M 50/131; H01M 50/105; H01M 50/126; H01M 2220/10; H01M 2220/20

(57) ABSTRACT

Disclosed are a secondary battery pouch film and a method for designing same, and a secondary battery using same and a method for manufacturing same, the secondary battery pouch film having at least an outer layer, a barrier layer, and a sealant layer sequentially laminated therein, wherein the weight per unit volume of the secondary battery film is greater than 1.45 mg/mm³ and less than 1.6 mg/mm³. Accordingly, by adjusting the weight per unit volume of the secondary battery pouch film and the weight of a pouch additionally used during forming, it is possible to very easily ensure the reliability and safety of the secondary battery pouch film while maximizing weight reduction. The secondary battery pouch film is particularly useful in the pouch manufacturing process for medium- to large-sized secondary batteries, especially secondary batteries for electric vehicles, which require weight reduction, reliability, and safety.

### TECHNICAL FIELD

This specification relates to a secondary battery pouch film having excellent weight reduction and stability, a method for designing the same, a secondary battery using the same, and a method for manufacturing the same. And more particularly, this specification relates to a secondary battery pouch film having excellent weight reduction and stability, a method for designing the same, a secondary battery using the same, and a method for manufacturing the same, in which insulation, formability, and the like are ensured, while maximizing weight reduction and maximizing energy density.

### NATIONAL RESEARCH AND DEVELOPMENT PROJECT THAT SUPPORTED THE INVENTION

[Project Unique Number] 1415185612
[Project Number] 20022450
[Department Name] Ministry of Trade, Industry and Energy
[Project Management (Specialized) Institution] Korea Evaluation Institute of Industrial Technology (KEIT)
[Research Project Name] Materials, Components, and Package-Type (Outstanding Company)
[Research Subject Name] Development of a Next-Generation Secondary Battery Pouch Capable of Achieving Twice or More High Adhesion Strength (60° C.)
[Contribution Rate] 1/1
[Project execution Institution] Youlchon Chemical Co., Ltd.
[Research Period] 2023 Jan. 1 to 2023 Dec. 31

### BACKGROUND ART

A lithium secondary battery (LiB) has been applied to many applications based on various advantages, such as high energy density and excellent output.

A lithium secondary battery is classified into a can type and a pouch type. In consideration of the freedom of battery form and the like, a pouch type battery is advantageous.

A secondary battery pouch film is a multi-layer packaging laminated film that surrounds the electrode assembly and electrolyte of such a secondary battery, and is a core component material that determines the stability, lifetime characteristics, and operational continuity of the battery. The secondary battery pouch film is required to have mechanical flexibility and strength, high oxygen/moisture barrier property, high thermal sealing strength, chemical resistance to the electrolyte, electrical insulation, and high-temperature stability.

The secondary battery pouch film is generally composed of multiple layers, typically and broadly comprising an outer layer, a barrier layer, and an inner sealant layer.

The outer layer or outermost layer is composed of nylon, or a blend material of nylon and polyethylene terephthalate (PET), oriented polypropylene (OPP), polyethylene, and the like. The required properties of the outer layer or outermost layer include heat resistance, pinhole resistance, chemical resistance, formability, and insulation.

The barrier layer is required to have barrier properties against moisture and other gases, as well as formability. From this perspective, formable metals, such as aluminum (Al), iron (Fe), copper (Cu), and nickel (Ni), are used for the barrier layer, and aluminum is currently the most widely used.

The inner sealant layer is required to have thermal adhesion, formability, and, as it is a layer in contact with the electrolyte, electrolyte resistance and insulation resistance.

As the application field of lithium secondary batteries expands from small-scale applications to medium and large-scale applications such as automotive and ESS, the secondary battery pouch film is also required to have characteristics suitable for medium and large-scale use. In particular, as lithium secondary batteries are used for applications such as electric vehicles (EVs), weight reduction of the secondary batteries has become a major issue.

### DISCLOSURE

### Technical Problem

In exemplary embodiments of the disclosure, in one aspect, there is provided a secondary battery pouch film, a secondary battery using the same, and a method for manufacturing the same, which may enable maximum possible weight reduction while ensuring reliability and safety of the secondary battery pouch film.

In exemplary embodiments of the disclosure, in another aspect, there is provided a novel and useful design parameters of secondary battery pouch film and a design method thereof, which may enable maximum possible weight reduction while ensuring reliability and safety of the secondary battery pouch film.

### Technical Solution

In the exemplary embodiments of the disclosure, there is provided a secondary battery pouch film, including: at least an outer layer, a barrier layer, and a sealant layer sequentially laminated, wherein a weight per unit volume, as measured by a method described below, is greater than 1.45 mg/mm³ and less than 1.6 mg/mm³.

### [Measurement of Weight per Unit Volume]

The pouch film is slit into a size of 10 cm (100 mm) in width and 10 cm (100 mm) in length, respectively, and ten sheets of each are collected as samples. A thickness of each pouch film samples is measured using a micrometer thickness gauge. In addition, an average weight of the samples is measured by weighing each of the samples of the ten sheets. The weight per unit volume is calculated using an equation below.

Weight per unit volume of pouch film=Average weight of samples of the ten sheets (g)/(100 mm×100 mm×Average thickness of samples of the ten sheets (μm))

In the exemplary embodiments of the disclosure, there is also provided a method for designing or manufacturing a secondary battery pouch film, in which the weight per unit volume of the pouch film, as measured by the above-described method, is greater than 1.45 mg/mm³ and less than 1.6 mg/mm³.

In the exemplary embodiments of the disclosure, there is also provided a method for improving weight reduction, insulation, and formability of a secondary battery pouch film, in which the weight per unit volume of the pouch film, as measured by the above-described method, is greater than 1.45 mg/mm³ and less than 1.6 mg/mm³.

In an exemplary embodiment, the secondary battery pouch film may have a weight of the pouch film used during forming, measured by the method described below, of 4.0 g or more and 7.0 g or less.

### [Measurement of Weight of Pouch Film Used During Forming]

The pouch film is slit into a size of 26 cm (260 mm) in width and 24 cm (240 mm) in length, respectively, and samples are collected accordingly. The collected samples are formed using a mold (16 cm×9 cm in size). Forming evaluations are repeated while changing the forming depth settings, and the evaluation is continued until ten or more samples do not break. A depth at which ten or more samples do not break is defined as a maximum forming depth. Each of internal volume of the pouch film during forming, volume of the pouch film used during forming, and a weight of the pouch film used during forming is calculated according to following equations.

Internal volume when forming pouch film=Internal area (160 mm×90 mm) when forming pouch film×Maximum forming depth of pouch film [Equation 2]

Volume of pouch film used during forming=[(160 mm+2×thickness of pouch film)×(90 mm+2×thickness of pouch film)×(maximum forming depth+thickness of pouch film)]−(160 mm×90 mm×maximum forming depth of pouch film) [Equation 3]

Weight of pouch film used during forming=Weight per unit volume of pouch film×Volume of pouch film used during forming [Equation 4]

In an exemplary embodiment, the secondary battery pouch film may have an insulation resistance, measured by the method described below, of 50 GΩ or more.

### [Insulation Resistance Evaluation]

The pouch film is slit into a size of 15 cm (150 mm) in width and 15 cm (150 mm) in length, respectively, and samples are collected accordingly. The collected samples are formed to a depth of 5 mm using a mold (4 cm×3 cm in size). A dummy cell is manufactured by injecting 2 mL of electrolyte and performing side sealing and tab sealing. After ten dummy cells per sample are manufactured, the resistance is measured after storing at room temperature for 24 hours and applying a voltage of 1,000 V. An insulation resistance value is an average value of the ten dummy cells.

During the insulation resistance measurement, sealing is performed under sealing conditions of 180° C. and 3 seconds.

In exemplary embodiments of the disclosure, there is also provided a secondary battery that is packaged with the above-described secondary battery pouch film.

In an exemplary embodiment, the secondary battery may be for use in an electric vehicle or an energy storage device.

Furthermore, in exemplary embodiments of the disclosure, there is provided a method for manufacturing a secondary battery, including a step of packaging the secondary battery with the above-described secondary battery pouch film.

### Advantageous Effects

In exemplary embodiments of the disclosure, weight reduction of the secondary battery pouch film may be maximized while ensuring reliability and safety of the secondary battery pouch film very easily, by adjusting the weight per unit volume of the secondary battery pouch film itself and, additionally, the weight of the pouch film used during forming. Such a secondary battery pouch film is particularly useful in the pouch manufacturing process of medium- to large-sized secondary batteries, particularly secondary batteries for electric vehicles, in which weight reduction, reliability, and safety are required.

### DESCRIPTION OF DRAWINGS

FIG. 1 is a schematic diagram illustrating an example of forming a secondary battery pouch film in an experimental example of the disclosure.

FIG. 2 is a graph illustrating insulation resistance values according to the weight per unit volume of the secondary battery pouch film in the experimental example of the disclosure.

FIG. 3 is a graph respectively illustrating the weight of the pouch film used during forming and the insulation resistance values according to the weight per unit volume of the secondary battery pouch film in the experimental example of the disclosure.

### MODE FOR DISCLOSURE

### Definition of Terms

In this specification, energy density refers to a state in which the weight of the pouch film used during forming is small and the forming depth is large.

In this specification, reliability and safety refer to characteristics directly related to secondary battery performance, and may representatively mean insulation or insulation resistance.

In this specification, when each layer of a secondary battery pouch is described as being included, it does not necessarily mean that the layer is composed of only the described layer, and additional layers may be included.

In this specification, when something is described as being “formed on” a specific layer, it includes not only being formed directly on the corresponding layer, but also being formed via additional other layers.

### DESCRIPTION OF EXEMPLARY EMBODIMENTS

Hereinafter, exemplary embodiments of the disclosure will be described in detail.

The forming depth of the pouch for medium- to large-sized secondary batteries, particularly for electric vehicles, is a factor that significantly affects the capacity of the secondary battery. As the forming depth of the secondary battery pouch increases, the battery capacity increases. However, from the perspective of safety, such as insulation (insulation resistance), disadvantages may occur.

To increase the forming depth of the secondary battery pouch film, the friction coefficients, etc. of the outer layer and the inner layer may be adjusted. However, since the secondary battery pouch film is composed of multiple layers made of various materials, it is practically difficult to satisfy both formability, and reliability and safety, such as insulation.

Under such circumstances, the inventors of the disclosure discovered that focusing on the weight, weight reduction, and energy density of the secondary battery pouch film itself, rather than the overall weight reduction of the secondary battery, may be a key to solving the technical challenges. Unexpectedly, when the total thickness of the pouch film is determined, it is considered that the weight of the pouch film is related to formability. Accordingly, when the total thickness of the pouch film is determined, it becomes possible to make adjustments to achieve maximum forming depth while achieving weight reduction.

Meanwhile, when the pouch film is designed solely for weight reduction of the secondary battery pouch film, not only formability but also reliability and safety, such as insulation resistance and bending, may become problematic. However, through repeated research, it is found that when the weight per unit volume of the secondary battery pouch film is controlled within a predetermined range, it is possible to achieve maximum weight reduction while ensuring formability, reliability, and safety of the secondary battery pouch film, thereby arriving at the disclosure.

Specifically, in the exemplary embodiments of the disclosure, there is provided a secondary battery pouch film, in which the weight per unit volume of a secondary battery pouch film having at least an outer layer, a barrier layer, and a sealant layer sequentially laminated is more than 1.45 mg/mm³ and less than 1.6 mg/mm³.

Here, the weight per unit volume of the secondary battery pouch film refers to a value obtained by dividing the weight of the corresponding secondary battery pouch film by a volume obtained by multiplying the area of the cut secondary battery pouch film for forming by its thickness. That is, it may be regarded as the density of the secondary battery pouch film. Specifically, the weight per unit volume is measured as follows.

### [Measurement of Weight Per Unit Volume]

The pouch film is slit into a size of 10 cm (100 mm) in width and 10 cm (100 mm) in length, respectively, and ten sheets of each are collected as samples. The thickness of each pouch film samples is measured using a micrometer thickness gauge, and the average thickness (μm) of the samples of the ten sheets is obtained. In addition, the weight of each of the samples of the ten sheets is measured, and the average weight (g) of the samples is measured. The weight per unit volume is measured according to [Equation 1] below.

Weight per unit volume of pouch film=Average weight of samples of the ten sheets (g)/(100 mm×100 mm×Average thickness of samples of the ten sheets (μm)) [Equation 1]

As can be seen from the experimental examples described below, when the weight per unit volume of the secondary battery pouch film is 1.6 mg/mm³ or more, the maximum forming depth becomes small, resulting in poor formability, or even if formability is good, the insulation becomes poor. In addition, when the weight per unit volume of the secondary battery pouch film is 1.45 mg/mm³ or less, formability deteriorates, pinholes may occur in the metal foil layer such as aluminum, and insulation may also deteriorate.

In an exemplary embodiment, the weight per unit volume of the secondary battery pouch film may be 1.46 mg/mm³, 1.47 mg/mm³, 1.48 mg/mm³, 1.49 mg/mm³, 1.50 mg/mm³, 1.51 mg/mm³, 1.52 mg/mm³, 1.53 mg/mm³, 1.54 mg/mm³, 1.55 mg/mm³, 1.56 mg/mm³, 1.57 mg/mm³, 1.58 mg/mm³, or 1.59 mg/mm³.

In an exemplary embodiment, the secondary battery pouch film may have a weight of the pouch film used during forming, measured by the method described below, of 4.0 g or more and 7.0 g or less.

### [Measurement of Weight of Pouch Film Used During Forming]

The pouch film is slit into a size of 26 cm (260 mm) in width and 24 cm (240 mm) in length, respectively, and samples are collected accordingly. The collected samples are formed using a mold (16 cm×9 cm in size). Forming evaluations are repeated while changing the forming depth settings, and the evaluation is continued until ten or more samples do not break. The depth at which ten or more samples do not break is defined as the maximum forming depth. Each of the internal volume during forming, the volume of the pouch film used during forming, and the weight of the pouch film used during forming is calculated according to the following equations.

Internal volume when forming pouch film=Internal area (160 mm×90 mm) when forming pouch film×Maximum forming depth of pouch film [Equation 2]

[Equation 3]

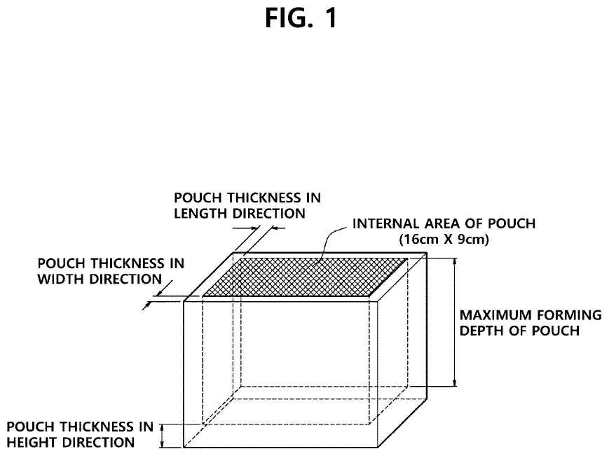

Volume of pouch film used during forming=[(160 mm+2×thickness of pouch film)×(90 mm+2×thickness of pouch film)× (maximum forming depth+thickness of pouch film)]−(160 mm×90 mm× maximum forming depth of pouch film). That is, with reference to FIG. 1, the value is obtained by subtracting the internal volume during forming of the pouch film from the total volume of the pouch during forming. Here, the thickness of the pouch film refers to the thickness in the width direction (16 cm side), the thickness in the length direction (9 cm side), and the thickness in the height direction, as illustrated in FIG. 1.

Weight of pouch film used during forming=Weight per unit volume of pouch film×Volume of pouch film used during forming [Equation 4]

In an exemplary embodiment, the weight of the pouch film used during forming may be 4.0 g or more, 4.1 g or more, 4.2 g or more, 4.3 g or more, 4.4 g or more, 4.5 g or more, 4.6 g or more, 4.7 g or more, 4.8 g or more, 4.9 g or more, 5.0 g or more, 5.1 g or more, 5.2 g or more, 5.3 g or more, 5.4 g or more, 5.5 g or more, 5.6 g or more, 5.7 g or more, 5.8 g or more, 5.9 g or more, 6.0 g or more, 6.1 g or more, 6.2 g or more, 6.3 g or more, 6.4 g or more, 6.5 g or more, 6.6 g or more, 6.7 g or more, 6.8 g or more, or 6.9 g or more. Or, the weight of the pouch film used during forming may be 7.0 g or less, 6.9 g or less, 6.8 g or less, 6.7 g or less, 6.6 g or less, 6.5 g or less, 6.4 g or less, 6.3 g or less, 6.2 g or less, 6.1 g or less, 6.0 g or less, 5.9 g or less, 5.8 g or less, 5.7 g or less, 5.6 g or less, 5.5 g or less, 5.4 g or less, 5.3 g or less, 5.2 g or less, 5.1 g or less, 5.0 g or less, 4.9 g or less, 4.8 g or less, 4.7 g or less, 4.6 g or less, 4.5 g or less, 4.4 g or less, 4.3 g or less, 4.2 g or less, or 4.1 g or less.

As confirmed in the experimental examples described below, when the weight of the pouch film used during forming is less than 4.0 g, insulation deteriorates and pinholes may occur in the metal layer, such as aluminum. As also confirmed in the experimental examples described below, when the weight of the pouch film used during forming exceeds 7.0 g, insulation again deteriorates and energy density during forming may be reduced.

In an exemplary embodiment, the secondary battery pouch film may have an insulation resistance, measured by the method described below, of 50 GΩ or more.

### [Insulation Resistance Evaluation]

The pouch film is slit into a size of 15 cm (150 mm) in width and 15 cm (150 mm) in length, respectively, and samples are collected accordingly. The collected samples are formed to a depth of 5 mm using a mold (4 cm×3 cm in size). A dummy cell is manufactured by injecting 2 mL of electrolyte and performing side sealing and tab sealing. After ten dummy cells per sample are manufactured, the resistance is measured after storing at room temperature for 24 hours and applying a voltage of 1,000 V. The insulation resistance value is the average value of the ten dummy cells. During the insulation resistance measurement, sealing is performed under sealing conditions of 180° C. and 3 seconds.

In an exemplary embodiment, the insulation resistance may be 50 GΩ or more, 55 GΩ or more, 60 GΩ or more, 65 GΩ or more, 70 GΩ or more, 75 GΩ or more, 80 GΩ or more, 85 GΩ or more, 90 GΩ or more, 95 GΩ, or 100 GΩ or more, and may be 100 GΩ or less, 200 GΩ or less, 300 GΩ or less, 400 GΩ or less, 500 GΩ or less, 600 GΩ or less, 700 GΩ or less, 800 GΩ or less, 900 GΩ or less, or 1,000 GΩ or less.

Compared to pouch films for small-sized secondary batteries, reliability and safety are particularly required for pouch films for secondary batteries for electric vehicles. Recently, more severe insulation resistance tests, such as application of 1,000 V, have been required, compared to conventional insulation resistance tests using 50 V, 100 V, and the like.

In an exemplary embodiment, the outer layer may be composed of nylon, polyethylene terephthalate (PET), polybutylene terephthalate (PBT), a composite layer of nylon and PET (a laminated film of nylon and PET), or the like.

In an exemplary embodiment, the nylon film among the outer layers preferably has a thickness of 20 μm or more in terms of formability, and more preferably 25 μm or more. However, when the thickness of the nylon film exceeds 30 μm, the dielectric breakdown voltage may decrease. Accordingly, the preferred thickness of the nylon film may be 20 μm to 30 μm, and more preferably 25 μm to 30 μm.

In an exemplary embodiment, the PET film among the outer layers has a smaller thickness, and the nylon film has a greater thickness, which is advantageous for formability. However, since a thinner PET film may be disadvantageous in terms of dielectric breakdown voltage, the PET film preferably has a thickness of 7 μm to 12 μm in view of such considerations.

In an exemplary embodiment, a matte layer may be coated on the outer surface of the outer layer, for example, the nylon layer. In a non-limiting example, the matte layer may include, for example, a polyurethane adhesive, silica, calcium carbonate, and the like.

In an exemplary embodiment, the matte layer may have a thickness of, for example, 0.5 to 3 μm.

In an exemplary embodiment, the sealant layer may be composed of a polypropylene (PP) layer, for example, a cast polypropylene (CPP) film, and the corresponding polypropylene (PP) layer and the barrier layer may be bonded by an extrusion coating (EC) layer made of polypropylene-based resin (EC method), or may be bonded after drying by using an adhesive such as a modified olefin-based adhesive (Solvent Dry Lamination method, i.e., SDL method). In the experimental examples, pouch films A, B, and C use the SDL method, while the others may be said to use the EC method.

In an exemplary embodiment, the polypropylene (PP) layer of the sealant layer may contain various additives (e.g., rubber, elastomer, slip agent, etc.) depending on the required physical properties.

In an exemplary embodiment, the barrier layer or the metal layer may be composed of metals such as aluminum, SUS alloy, or copper, and may have moisture permeability and impact resistance. One or both surfaces of the corresponding metal layer may be coated with a corrosion prevention treatment solution (chromate-based) to form a corrosion prevention layer.

In an exemplary embodiment, the total thickness of the secondary battery pouch film may be, for example, 60 to 220 μm.

In an exemplary embodiment, the thickness of the barrier layer or the metal layer may be, for example, 20 to 80 μm, and preferably 40 to 60 μm.

In an exemplary embodiment, the barrier layer or the metal layer and the outer layer may be bonded by an adhesive layer. In a non-limiting example, the adhesive of the adhesive layer may be, for example, a two-component curable polyurethane adhesive, and additionally, carbon black may be added in an amount of about 1 to 10 wt % to the adhesive composition of the adhesive layer.

In an exemplary embodiment, the thickness of the sealant layer may be, for example, 20 to 80 μm.

In an exemplary embodiment, the thickness of the cast polypropylene (CPP) film layer of the sealant layer may be, for example, 20 to 80 μm.

In an exemplary embodiment, in case of the EC method, the thickness of the extruded polypropylene (PP) layer of the sealant layer may be, for example, 0 to 60 μm. In case of the SDL method, the modified olefin-based adhesive layer may be, for example, 1 to 5 μm.

Meanwhile, in exemplary embodiments of the disclosure, there is provided a method for designing (or manufacturing) a secondary battery pouch film, in which the weight per unit volume of a secondary battery pouch film cut for forming is set to be greater than 1.45 mg/mm³ and less than 1.6 mg/mm³.

In addition, in exemplary embodiments of the disclosure, there is provided a method for improving weight reduction, insulation, and formability of a secondary battery pouch film, in which the weight per unit volume of the secondary battery pouch film cut for forming is set to be greater than 1.45 mg/mm³ and less than 1.6 mg/mm³.

Further, in exemplary embodiments of the disclosure, there is provided a secondary battery that is packaged with the above-described secondary battery pouch film.

In an exemplary embodiment, the secondary battery may be for use in an electric vehicle or an energy storage device.

Furthermore, in exemplary embodiments of the disclosure, there is provided a method for manufacturing a secondary battery, including a step of packaging the secondary battery with the above-described secondary battery pouch film.

The exemplary embodiments of the disclosure will now be described in more detail with reference to the following examples. The embodiments disclosed in this specification are merely provided by way of example for descriptive purposes, and the embodiments of the disclosure may be implemented in various forms, and should not be construed as being limited to the embodiments described in this specification.

### EXPERIMENT

### <Manufacture of Secondary Battery Pouch Film>

Secondary battery pouch films A to K are manufactured as described below. Among the films, films E, F, H, I, and J correspond to examples, and the remaining films correspond to comparative examples.

### 1. Pouch Film A

1) A corrosion prevention layer is formed by coating both surfaces of an aluminum foil having a thickness of 30 μm with a corrosion prevention treatment solution (chromate-based).

2) The inner surface of a nylon film having a thickness of 15 μm and the outer surface of the aluminum foil of 1) are laminated using a black adhesive layer. The black adhesive layer is composed of a two-component curable polyurethane adhesive and carbon black [carbon black may be added in an amount of about 1 to 10 wt % based on the adhesive composition, and 5 wt % is added in this film manufacturing].

3) A matte layer is coated on the outer surface of the nylon film. The matte layer is composed of a polyurethane adhesive, silica, and calcium carbonate (composed of 8 wt % polyurethane, 12 wt % silica and calcium carbonate, and 80 wt % other solvents and the like).

4) A CPP film having a thickness of 22 μm and the inner surface of the aluminum foil are laminated using a modified olefin-based adhesive layer.

5) A secondary battery pouch film having the structure of matte layer/nylon film layer/black adhesive layer/outer corrosion prevention layer/aluminum foil layer/inner corrosion prevention layer/modified olefin-based adhesive layer/CPP film layer is obtained.

### 2. Pouch Film B

1) A corrosion prevention layer is formed by coating both surfaces of an aluminum foil having a thickness of 35 μm with a corrosion prevention treatment solution (chromate-based).

2) The inner surface of a nylon film having a thickness of 15 μm and the outer surface of the aluminum foil of 1) are laminated using a two-component curable polyurethane-based outer adhesive layer.

3) A CPP film having a thickness of 30 μm and the inner surface of the aluminum foil are laminated using a modified olefin-based adhesive layer.

4) A secondary battery pouch film having a structure of nylon film layer/outer adhesive layer/outer corrosion prevention layer/aluminum foil layer/inner corrosion prevention layer/modified olefin-based adhesive layer/CPP film layer is obtained.

### 3. Pouch Film C

1) A corrosion prevention layer is formed by coating both surfaces of an aluminum foil having a thickness of 35 μm with a corrosion prevention treatment solution (chromate-based).

2) The inner surface of a nylon film having a thickness of 15 μm and the outer surface of the aluminum foil of 1) are laminated using a black adhesive layer. The black adhesive layer is the same as that used in pouch film A.

3) A matte layer is coated on the outer surface of the nylon film. The matte layer is the same as that used in pouch film A.

4) A CPP film having a thickness of 30 μm is laminated to the inner surface of the aluminum foil using a modified olefin-based adhesive layer.

5) A secondary battery pouch film having the structure of matte layer/nylon film layer/black adhesive layer/outer corrosion prevention layer/aluminum foil layer/inner corrosion prevention layer/modified olefin-based adhesive layer/CPP film layer is obtained.

### 4. Pouch Film D

1) A corrosion prevention layer is formed by coating both surfaces of an aluminum foil having a thickness of 40 μm with a corrosion prevention treatment solution (chromate-based).

2) The inner surface of a nylon film having a thickness of 25 μm and the outer surface of the aluminum foil of 1) are laminated using a two-component curable polyurethane-based outer adhesive layer.

3) A primer layer (including a modified olefin-based resin) is coated and dried on the inner corrosion prevention layer of the multilayer film obtained in 2).

4) A CPP film having a thickness of 28 μm and the inner surface of the aluminum foil are laminated using an olefin-based extrusion layer (of a thickness of 17 μm).

5) A secondary battery pouch film having a structure of nylon film layer/outer adhesive layer/outer corrosion prevention layer/aluminum foil layer/inner corrosion prevention layer/primer layer/olefin-based extrusion layer/CPP film layer is obtained.

### 5. Pouch Film E

1) A corrosion prevention layer is formed by coating both surfaces of an aluminum foil having a thickness of 40 μm with a corrosion prevention treatment solution (chromate-based).

2) A PET film having a thickness of 12 μm and a nylon film having a thickness of 15 μm are laminated using a two-component curable polyurethane-based adhesive layer (outer adhesive layer 1).

3) The multilayer film obtained in 2) and the outer surface of the aluminum foil of 1) are laminated using a two-component curable polyurethane-based outer adhesive layer (outer adhesive layer 2).

4) A primer layer (including a modified olefin-based resin) is coated and dried on the inner corrosion prevention layer of the multilayer film obtained in 3).

5) A CPP film having a thickness of 50 μm and the inner surface of the aluminum foil are laminated using an olefin-based extrusion layer (of a thickness of 30 μm).

6) A secondary battery pouch film having a structure of PET film layer/outer adhesive layer 1/nylon film layer/outer adhesive layer 2/outer corrosion prevention layer/aluminum foil layer/inner corrosion prevention layer/primer layer/olefin-based extrusion layer/CPP film layer is obtained.

### 6. Pouch Film F

1) A corrosion prevention layer is formed by coating both surfaces of an aluminum foil having a thickness of 60 μm with a corrosion prevention treatment solution (chromate-based).

2) A PET film having a thickness of 12 μm and a nylon film having a thickness of 25 μm are laminated using a two-component curable polyurethane-based adhesive layer (outer adhesive layer 1).

3) The multilayer film obtained in 2) and the outer surface of the aluminum foil of 1) are laminated using a two-component curable polyurethane-based outer adhesive layer (outer adhesive layer 2).

4) A primer layer (including a modified olefin-based resin) is coated and dried on the inner corrosion prevention layer of the multilayer film obtained in 3).

5) A CPP film having a thickness of 50 μm and the inner surface of the aluminum foil are laminated using an olefin-based extrusion layer (of a thickness of 30 μm).

6) A secondary battery pouch film having a structure of PET film layer/outer adhesive layer 1/nylon film layer/outer adhesive layer 2/outer corrosion prevention layer/aluminum foil layer/inner corrosion prevention layer/primer layer/olefin-based extrusion layer/CPP film layer is obtained.

### 7. Pouch Film G

1) A corrosion prevention layer is formed by coating both surfaces of an aluminum foil having a thickness of 80 μm with a corrosion prevention treatment solution (chromate-based).

2) A PET film having a thickness of 12 μm and a nylon film having a thickness of 25 μm are laminated using a two-component curable polyurethane-based adhesive layer (outer adhesive layer 1).

3) The multilayer film obtained in 2) and the outer surface of the aluminum foil of 1) are laminated using a two-component curable polyurethane-based outer adhesive layer (outer adhesive layer 2).

4) A primer layer (including a modified olefin-based resin) is coated and dried on the inner corrosion prevention layer of the multilayer film obtained in 3).

5) A CPP film having a thickness of 40 μm and the inner surface of the aluminum foil are laminated using an olefin-based extrusion layer (of a thickness of 20 μm).

6) A secondary battery pouch film having a structure of PET film layer/outer adhesive layer 1/nylon film layer/outer adhesive layer 2/outer corrosion prevention layer/aluminum foil layer/inner corrosion prevention layer/primer layer/olefin-based extrusion layer/CPP film layer is obtained.

### 8. Pouch Film H

1) A corrosion prevention layer is formed by coating both surfaces of an aluminum foil having a thickness of 60 μm with a corrosion prevention treatment solution (chromate-based).

2) A PET film having a thickness of 12 μm and a nylon film having a thickness of 25 μm are laminated using a two-component curable polyurethane-based adhesive layer (outer adhesive layer 1).

3) The multilayer film obtained in 2) and the outer surface of the aluminum foil of 1) are laminated using a two-component curable polyurethane-based outer adhesive layer (outer adhesive layer 2).

4) A primer layer (including a modified olefin-based resin) is coated and dried on the inner corrosion prevention layer of the multilayer film obtained in 3).

5) A CPP film having a thickness of 70 μm and the inner surface of the aluminum foil are laminated using an olefin-based extrusion layer (of a thickness of 30 μm).

6) A secondary battery pouch film having a structure of

PET film layer/outer adhesive layer 1/nylon film layer/outer adhesive layer 2/outer corrosion prevention layer/aluminum foil layer/inner corrosion prevention layer/primer layer/olefin-based extrusion layer/CPP film layer is obtained.

### 9. Pouch Film I

1) A corrosion prevention layer is formed by coating both surfaces of an aluminum foil having a thickness of 40 μm with a corrosion prevention treatment solution (chromate-based).

2) A PET film having a thickness of 12 μm and a nylon film having a thickness of 15 μm are laminated using a two-component curable polyurethane-based adhesive layer (outer adhesive layer 1).

3) The multilayer film obtained in 2) and the outer surface of the aluminum foil of 1) are laminated using a two-component curable polyurethane-based outer adhesive layer (outer adhesive layer 2).

4) A modified olefin-based extrusion layer having a thickness of 40 μm is laminated onto the inner corrosion prevention layer of the multilayer film obtained in 3).

5) An olefin-based extrusion layer (of a thickness of 40 μm) is laminated onto the modified olefin-based extrusion layer obtained in 4).

6) A secondary battery pouch film having a structure of PET film layer/outer adhesive layer 1/nylon film layer/outer adhesive layer 2/outer corrosion prevention layer/aluminum foil layer/inner corrosion prevention layer/modified olefin-based extrusion layer/olefin-based extrusion layer is obtained.

### 10. Pouch Film J

1) A corrosion prevention layer is formed by coating both surfaces of an aluminum foil having a thickness of 60 μm with a corrosion prevention treatment solution (chromate-based).

2) A PET film having a thickness of 12 μm and a nylon film having a thickness of 25 μm are laminated using a two-component curable polyurethane-based adhesive layer (outer adhesive layer 1).

3) The multilayer film obtained in 2) and the outer surface of the aluminum foil of 1) are laminated using a two-component curable polyurethane-based outer adhesive layer (outer adhesive layer 2).

4) A modified olefin-based extrusion layer having a thickness of 40 μm is laminated onto the inner corrosion prevention layer of the multilayer film obtained in 3).

5) An olefin-based extrusion layer (of a thickness of 40 μm) is laminated onto the modified olefin-based extrusion layer obtained in 4).

6) A secondary battery pouch film having a structure of PET film layer/outer adhesive layer 1/nylon film layer/outer adhesive layer 2/outer corrosion prevention layer/aluminum foil layer/inner corrosion prevention layer/modified olefin-based extrusion layer/olefin-based extrusion layer is obtained.

### 11. Pouch Film K

1) A corrosion prevention layer is formed by coating both surfaces of an aluminum foil having a thickness of 30 μm with a corrosion prevention treatment solution (chromate-based).

2) The inner surface of a nylon film having a thickness of 25 μm and the outer surface of the aluminum foil of 1) are laminated using a two-component curable polyurethane-based outer adhesive layer.

3) A primer layer (including a modified olefin-based resin) is coated and dried on the inner corrosion prevention layer of the multilayer film obtained in 2).

4) A CPP film having a thickness of 33 μm and the inner surface of the aluminum foil are laminated using an olefin-based extrusion layer (of a thickness of 17 μm).

5) A secondary battery pouch film having a structure of nylon film layer/outer adhesive layer/outer corrosion prevention layer/aluminum foil layer/inner corrosion prevention layer/primer layer/olefin-based extrusion layer/CPP film layer is obtained.

### <Measurement of Thickness and Weight of Secondary Battery Pouch Film>

The manufactured secondary battery pouch films A to K are slit into a size of 10 cm in width and 10 cm in length, respectively, and ten sheets of each are collected as samples. The thickness of the pouch films (average thickness of the samples of the ten sheets) is measured using a micrometer thickness gauge. In addition, the weight of each samples of ten sheets is measured to obtain the average weight of the samples. The table below shows the measured thickness, weight (average weight), and weight per unit volume of each sample.

TABLE 1

| | Average | Average | Weight per |
|---|---|---|---|
| Pouch | thickness | weight | unit volume* |
| film | (μm) | (g) | (mg/mm³) |
| A | 76 | 1.2791 | 1.683 |
| B | 88 | 1.4718 | 1.673 |
| C | 90 | 1.4836 | 1.648 |
| D | 113 | 1.8083 | 1.600 |
| E | 153 | 2.2507 | 1.471 |
| F | 183 | 2.8609 | 1.563 |
| G | 183 | 3.2080 | 1.753 |
| H | 203 | 3.0861 | 1.520 |
| I | 151 | 2.2131 | 1.466 |
| J | 181 | 2.8447 | 1.572 |
| K | 113 | 1.6326 | 1.445 |

*Weight per unit volume = Average weight of samples of ten sheets (g) / (100 mm × 100 mm × average thickness of samples of ten sheets (μm))

### <Measurement of Maximum Forming Depth of Secondary Battery Pouch Film>

The manufactured secondary battery pouch films A to K are slit into a size of 26 cm in width and 24 cm in length, respectively, and samples are collected. Each of the collected samples is formed using a test mold (16 cm×9 cm in size) of Youlchon Chemical, as illustrated in FIG. 1. Forming evaluations are repeated while changing the forming depth settings, and the evaluation is continued until ten or more samples do not break. The depth at which ten or more samples do not break is defined as the maximum forming depth. The maximum forming depth of each pouch film is shown in the table below.

TABLE 2

| | Maximum |
|---|---|
| Pouch | forming |
| film | depth (mm) |
| A | 6 |
| B | 9 |
| C | 9.5 |
| D | 14.5 |
| E | 15 |
| F | 15 |
| G | 16 |
| H | 12.5 |
| I | 11 |
| J | 13 |
| K | 10 |

### <Volume and Weight of Secondary Battery Pouch Film During Forming>

The internal area during forming, internal volume during forming, volume of pouch film used during forming, and weight of pouch film used during forming for each secondary battery pouch film are calculated as follows. Based on these, the internal forming volume per unit weight of the pouch film used during forming is calculated. The results are shown in the table below.

TABLE 3

| | Internal | Internal | Volume of | Weight of |
|---|---|---|---|---|
| | area | volume | pouch film | pouch film |
| | during | during | used during | used during |
| Pouch | forming | forming* | forming** | forming*** |
| film | (mm²) | (mm³) | (mm³) | (g) |
| A | 14400 | 86400 | 1325 | 2.231 |
| B | 14400 | 129600 | 1667 | 2.789 |
| C | 14400 | 136800 | 1728 | 2.848 |
| D | 14400 | 208800 | 2454 | 3.926 |
| E | 14400 | 216000 | 3364 | 4.948 |
| F | 14400 | 216000 | 4026 | 6.295 |
| G | 14400 | 230400 | 4118 | 7.219 |
| H | 14400 | 180000 | 4215 | 6.407 |
| I | 14400 | 158400 | 3017 | 4.422 |
| J | 14400 | 187200 | 3801 | 5.974 |
| K | 14400 | 144000 | 2.199 | 3.177 |

*Internal volume during forming: Internal area during forming (160 mm × 90 mm) × Maximum forming depth
**Volume of pouch film used during forming: [(160 mm + 2× thickness of pouch film) × (90 mm + 2× thickness of pouch film) × (maximum forming depth + thickness of pouch film)] − (160 mm × 90 mm × maximum forming depth of pouch film). Here, the thickness of the pouch film refers to the thickness in the width direction (16 cm side), the thickness in the length direction (9 cm side), and the thickness in the height direction, as illustrated in FIG. 1.
***Weight of pouch film used during forming: Weight per unit volume of pouch film × Volume of pouch film used during forming

### <Measurement of 1,000 V Insulation Resistance>

The insulation resistance is evaluated by forming the samples using a test mold (4 cm×3 cm in size) of Youlchon Chemical to a depth of 5 mm. That is, the manufactured secondary battery pouch films A to K are slit into a size of 15 cm in width and 15 cm in length, respectively, and samples are collected. Each of the collected samples are formed to a depth of 5 mm using the test mold (4 cm×3 cm in size), and dummy cells are manufactured by performing side sealing and tab sealing, based on 2 ml of electrolyte. After ten dummy cells per sample are manufactured, resistance is measured when a voltage of 1,000 V is applied after 24 hours had elapsed. The insulation resistance value is obtained from the average value of the ten dummy cells. The sealing conditions during the sealing process are 180° C. for 3 seconds.

The measurement results are shown in the table below.

TABLE 4

| | Insulation |
|---|---|
| Pouch | resistance |
| film | (GΩ) |
| A | 0 |
| B | 0 |
| C | 0 |
| D | 0 |
| E | 60 |
| F | 60 |
| G | 30 |
| H | 100 |
| I | 90 |
| J | 90 |
| K | 0 |

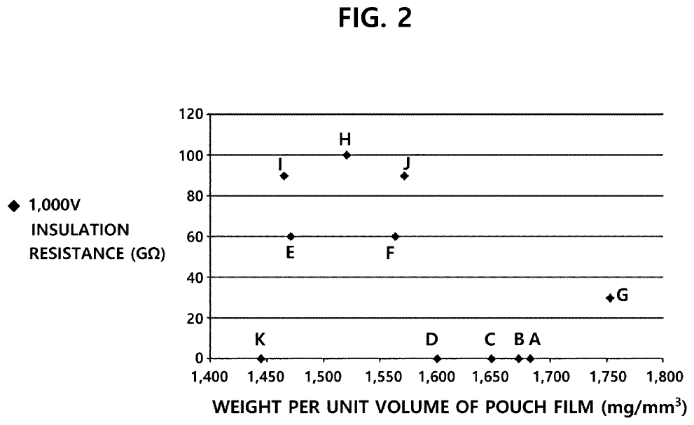

FIG. 2 is a graph illustrating insulation resistance values according to the weight per unit volume of the secondary battery pouch film in the experimental example of the disclosure. FIG. 2 visually illustrates the range of secondary battery pouch films that exhibit weight reduction while being significantly excellent in reliability and safety (insulation resistance). It can be seen that, when the weight per unit volume of the secondary battery pouch film is greater than 1.45 mg/mm³ and less than 1.6 mg/mm³ (secondary battery pouch films E, F, H, I, and J), the insulation resistance at 1,000 V is 50 GΩ or higher, which is significantly superior compared to those outside this range (secondary battery pouch films A, B, C, D, G, and K).

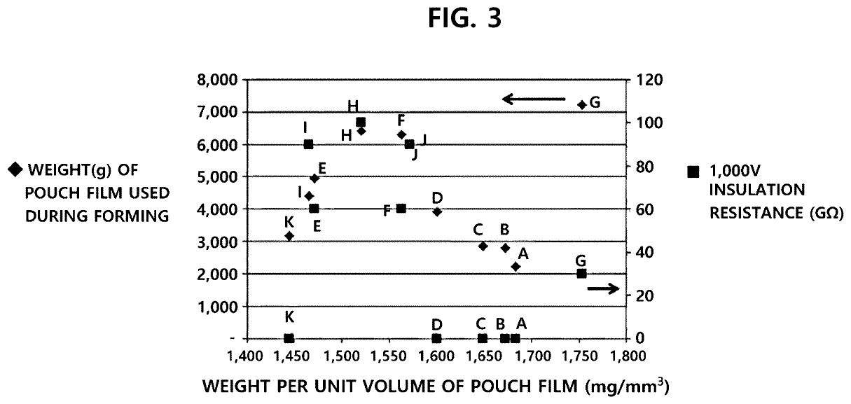

Meanwhile, FIG. 3 is a graph respectively illustrating the weight of the pouch film used during forming and the insulation resistance values according to the weight per unit volume of the secondary battery pouch film in the experimental example of the disclosure.

FIG. 3 also visually shows the optimal range of weight per unit volume of the pouch film, which is excellent in reliability and safety (insulation resistance) while achieving weight reduction. That is, it can be seen that, when the weight per unit volume of the secondary battery pouch film is greater than 1.45 mg/mm³ and less than 1.6 mg/mm³ (secondary battery pouch films E, F, H, I, and J), the insulation resistance at 1,000 V is 50 GΩ or higher, and the optimal weight of pouch film used during forming is within the range of 4.0 g or more and 7.0 g or less.

As described above, in the exemplary embodiments of the disclosure, by controlling the weight per unit volume of the secondary battery pouch film to be greater than 1.45 mg/mm³ and less than 1.6 mg/mm³, and further by controlling the weight of pouch film used during forming to be 4.0 g or more and 7.0 g or less, it is possible to simultaneously satisfy weight reduction and reliability and safety (insulation resistance, etc.). Therefore, the weight per unit volume of the secondary battery pouch film, and additionally the weight of the pouch film used during forming, may be used as novel and useful design parameters for secondary battery pouch films.

Although the above describes non-limiting and exemplary embodiments of the disclosure, the technical spirit of the disclosure is not limited to the accompanying drawings or the foregoing description. It will be apparent to those of ordinary skill in the art that various modifications may be made without departing from the technical spirit of the disclosure, and such modifications shall fall within the scope of the claims of the disclosure.

### INDUSTRIAL APPLICABILITY

The secondary battery pouch film of the disclosure is particularly useful in pouch manufacturing processes of medium- to large-sized secondary batteries, especially secondary batteries for electric vehicles, in which weight reduction, reliability, and safety are particularly required.

1. A secondary battery pouch film, comprising:
at least an outer layer, a barrier layer, and a sealant layer sequentially laminated,
wherein a weight per unit volume is greater than 1.45 mg/mm³ and less than 1.6 mg/mm³.

2. The secondary battery pouch film of claim 1, wherein the secondary battery pouch film has a weight of a pouch film used during forming is 4.0 g or more and 7.0 g or less.

3. The secondary battery pouch film of claim 2, wherein the secondary battery pouch film has insulation resistance of 50 GΩ or more.

4. A method for designing a secondary battery pouch film, wherein a weight per unit volume is greater than 1.45 mg/mm³ and less than 1.6 mg/mm³.

5. The method of claim 4, wherein a weight of a pouch film used during forming is 4.0 g or more and 7.0 g or less.

6. The method of claim 5, wherein an insulation resistance is 50 GΩ or more.

7. A secondary battery, which is packaged with the secondary battery pouch film according to claim 1.

8. The secondary battery of claim 7, wherein the secondary battery is for use in an electric vehicle or an energy storage device.

9. (canceled)
